(19) United States
(12) Patent Application Publication
(10) Pub. No.: US 2010/0191631 A1
(43) Pub. Date: Jul. 29, 2010

(54) QUANTITATIVE MEDIA VALUATION METHOD, SYSTEM AND COMPUTER PROGRAM

(76) Inventor: Adrian Weidmann, Deephaven, MN (US)

Correspondence Address: Altera Law Group, LLC, 220 S 6 St Suite 1700, Minneapolis, MN, 55402, US

(21) Appl. No.: 12/695,471

(22) Filed: Jan. 28, 2010

Related U.S. Application Data
(60) Provisional application No. 61/148,129, filed on Jan. 29, 2009.

(51) Int. Cl. G06Q 50/00; G06Q 30/00; H04N 5/66; H04N 7/18

(52) U.S. Cl. 705/34; 348/739; 348/135; 348/E05.133; 348/E07.086

(57) ABSTRACT

A method and system are disclosed for transforming accessing of a displayed content by at least one person into an overall billed value. An exemplary embodiment comprises providing a display device that displays content, tracking the respective gazes of people near and in front of the displayed content, determining if, when and how long each person views, i.e., acquires, the display, transforming the acquisition data into a billing value by, e.g., determining a billing value for each acquisition based on the numbers of acquisitions and length of each acquisition, summing the billing values for all the respective viewings, and billing the client for the summed billing values.

### CROSS-REFERENCE TO RELATED APPLICATIONS

The present application claims priority under 35 U.S.C §119(e) to provisional application No. 61/148,129, filed on Jan. 29, 2009, under the same title. Full Paris Convention priority is hereby expressly reserved.

### STATEMENT REGARDING FEDERALLY SPONSORED RESEARCH OR DEVELOPMENT

Not Applicable

### BACKGROUND OF THE INVENTION

1. Field of the Invention

The present invention is directed to tracking the acquisitions of content on a display, and generating a monetary value based on the number and lengths of the acquisitions of the displayed content.

2. Description of the Related Art

Commercial, or other, content, may be disseminated to the public through media sources such as radio, television, print, billboards, signage, online and mobile. In certain business models, e.g., a company supplies content to be displayed and that is aimed at attracting potential customers for the company and/or its commercial brand vendor partners. For example, the potential customer(s) and/or client(s) may acquire the displayed content through the intended means, i.e., visually, hearing and/or touching the displayed content. This content display, playing or otherwise communicating content, i.e., advertising, merchandising, promotion and/or general communication, referred to hereinafter as AMPC may have an applied value and be purchased. Those purchasing the AMPC through a media company, or developing the AMPC and displaying without aid of a media company, want to know as much as possible about the audience and the actual number of people that their advertising reaches. Many years ago, the information provided to advertising clients was simply an unverified theoretical number of people reached by the advertisement. This number of viewers/listeners was easily obtainable through subscription numbers for print media, and through statistically-based ratings numbers for broadcast media.

One established metric used by the advertising/media buying and selling community for quantifying the audience is gross rating points (GRP). Two well-established metrics for valuing the cost of advertising are cost-per-thousand (CPM) and cost-per-point (CPP). These are based upon traditional “reach and frequency” media valuation parameters. All of these are described in detail below.

GRP (gross rating points) is the sum of ratings achieved by a specific media vehicle or schedule. GRP represents the percentage of the target audience reached by a particular advertisement. For example, for an ad airing once and reaching 50% of its target audience, the ad is said to have a 50 GRP. If the advertisement appears more than once, the GRP figure represents the sum of each individual GRP. For instance, if a particular TV ad airs five times, each time reaching 50% of the target audience, the ad is said to have 250 GRP. In general, Gross Rating Points is the frequency of repetition, multiplied by the percentage of reach.

The CPM (cost-per-thousand) is defined as the cost of the advertising schedule, divided by the gross number of impressions, times 1000. In general, CPM is the cost required to reach one thousand people. The CPP (cost-per-point) is defined as the cost of the advertising schedule, divided by the gross rating points (GRP). In general, CPP is the cost required to reach one rating point, or one percentage point of the audience in the targeted area. Both of these quantities are made clearer by the following numerical example.

A geographic area being evaluated might be a country, such as the United States, or a specific television market, such as New York City. The major broadcast networks cover virtually all of the United States, and A.C. Nielsen, the company that provides television networks, television stations, and advertisers with the audience measurement, or rating, information, measures their audiences.

A typical television market covers a generally circular area, with a radius of about 75 miles (120 km) away from the stations' transmitters. In addition, the market also covers cable and satellite television subscribers that also receive the local stations' signals. One of the companies that measures television audiences, A.C. Nielsen, refers to this geographic area as a Designated Marketing Area (DMA). A typical DMA encompasses several counties and many cities, and is usually designated by the largest city in the area. Hence, the New York City market includes Newark in New Jersey, Port Jefferson Station on Long Island, Nanuet in New York, and Stamford in Connecticut.

The average television network program achieves about an 11.0 rating, which means that it reaches 11% of the 94,000,000 homes in America with television sets, or approximately 10,300,000 homes. If an advertiser were to buy ten commercials, each with a rating of 11.0 on a TV network, then the number of gross impressions would be 10 times 10,300,000, or 103,000,000. If the TV network were to charge an average of $150,000 for a typical 30-second-length commercial, the total cost of a ten-commercial schedule would be $1,500,000. The CPM of the schedule would be: ($1,500,000)/(103,000,000)×1000, or $14.56. In other words, for this sample advertising schedule, it costs $14.56 to reach 1000 viewers (or, equivalently, generate 1000 gross impressions).

Advertisers and their advertising agencies and media buying services evaluate television networks based on CPM because it has historically been a universally accepted comparative measure of media efficiency across several media. Thus, the cost of reaching 1000 viewers with the above sample advertising schedule on a TV network could be compared, for example, with how much it costs to reach 1000 readers with an ad in a magazine or newspaper.

It would be desirable to document the effectiveness of any kind of AMPC media, and to have the ability to generate an accurate value and associated billing based upon actual viewings or other type of behavioral engagement such as, but not limited to, sound, tactile, motion interaction(s). Moreover, recently, the distribution of media has grown to include the internet, cellular phones, digital billboards, and other new technology. Likewise, just as the media itself has become more sophisticated, the demands placed on identification and categorization of a particular advertiser's target audience have become more technologically complex.

For instance, and without limitation, for a digital AMPC message on a digital billboard, or a non-digital billboard, or a digital, or non-digital, sign in a public location, it may be desirable to bill a client using real, measured data of how often the particular message is viewed, what portions of the message are viewed, and for how long the message is viewed. This type of audience measurement and categorization is impossible with conventional ratings measurement schemes.

Accordingly, there exists a need for more sophisticated audience measurement and categorization for digital media displays, such as for AMPC communication, or any other suitable purpose.

### BRIEF SUMMARY OF THE INVENTION

An embodiment is a method for billing a client, comprising: displaying content corresponding to the client to a transient plurality of people on a display device; documenting, for a predetermined time period, all acquisitions of the displayed content for all people in the transient plurality with a documentation device; transforming the documented acquisitions into a predetermined value with a transforming device; and generating a bill for the client for the predetermined value.

### BRIEF DESCRIPTION OF THE SEVERAL VIEWS OF THE DRAWINGS

FIG. 1 is one embodiment of the present invention.

FIG. 2 is a plot of a sample viewing, as function of time of one embodiment of the present invention.

FIG. 3 is one embodiment of the present invention.

FIG. 4 is a plot of sample viewings for two viewers, as function of time of one embodiment of the present invention.

FIG. 5 is a schematic drawing of the information recorded at a typical display of one embodiment of the present invention.

FIG. 6 is a schematic drawing of a camera and media playback system with two displays, each with its own display and camera of one embodiment of the present invention.

FIG. 7 is a schematic drawing of a sample viewer log and sample billable rate lookup table, for a particular piece of content of one embodiment of the present invention.

FIG. 8 is a flow chart of a sample billing process of one embodiment of the present invention.

FIG. 9 is a plot of a sample viewing extending across more than one piece of content of one embodiment of the present invention.

### DETAILED DESCRIPTION OF THE INVENTION

A method and system are disclosed for transforming accessing of a displayed content by at least one person into an overall billed value. An exemplary embodiment comprises providing a display device that displays content, tracking the respective gazes of people near and in front of the displayed content, determining if, when and how long each person views, i.e., acquires, the display, transforming the acquisition data into a billing value by, e.g., determining a billing value for each acquisition based on the numbers of acquisitions and length of each acquisition, summing the billing values for all the respective viewings, and billing the client for the summed billing values. In some embodiments, the system may comprise an eye tracker to monitor the respective gaze directions of the people near the display. In other embodiments, the display device may comprise multiple display screens in the same general physical location, and the gaze tracking technology determines which screen in the display is being viewed. In other embodiments, the billing value is tabulated as a lookup table, with predetermined values for a given plurality of acquisition times and a given plurality of acquisition lengths of a particular piece of unique content. Acquisition times may include a start time, an end time, or any prescribed point within the acquisition. In some embodiments, the system includes multiple displays in different locations, each display location having its own gaze tracking camera and processing technology. In some of those embodiments, each display has its own set of billable values or its own lookup table associated with each unique piece of content.

The terms “acquire” and “acquisition” are intended to mean, for purposes of the present invention, any means by which a person, e.g., a potential customer or consumer, accesses the displayed content. Thus, an acquisition of the displayed content may, in various embodiments, comprise seeing, hearing, and/or touching/tactile or otherwise perceiving the displayed content.

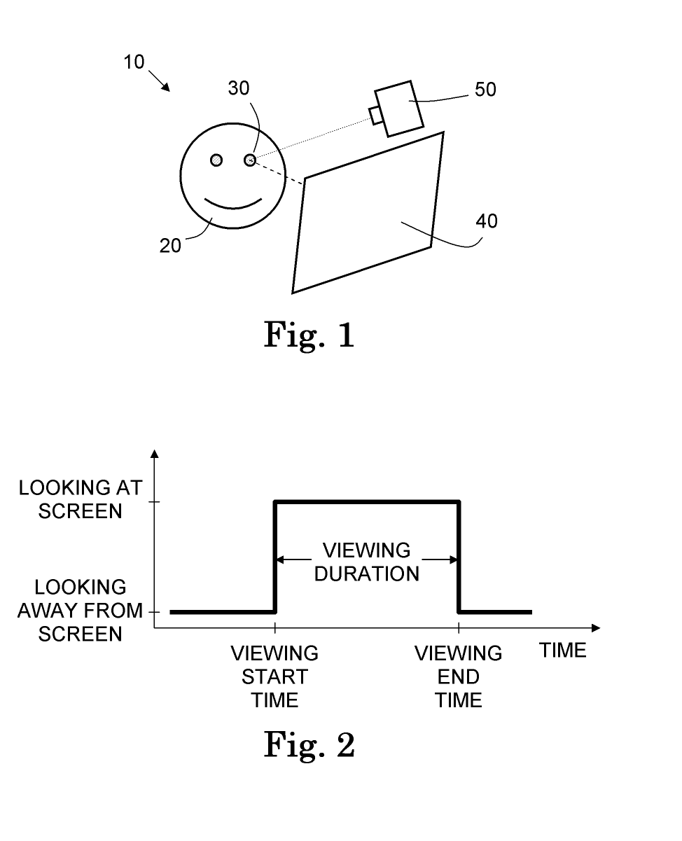

Turning now to the figures, FIG. 1 is a schematic drawing of an exemplary embodiment of a display system 10 with a single viewer. In some cases, the display system 10 may be set up in or outside a store, in an office building lobby, as a digital or non-digital billboard or signage, or in some other suitable public place where it can catch the attention of and be viewed by passers-by. In some embodiments, the display system 10 may be understood as what is commonly referred to as a “kiosk”.

The display system comprises a display device which may comprise a display screen 40, in the case of video-based content, which may include a cathode ray tube (CRT), a plasma screen, a screen having a backlight and a liquid crystal display (LCD), an array of organic light emitting diodes (OLED), an array of light emitting diodes (LED), or any other suitable dynamic electronic display mechanism. Alternatively, the display screen 40, as shown, may simply be a static image of a poster or sign.

The display screen 40 displays content provided by one or more clients and intended for acquisition by at least one person, i.e., a potential customer or client. The content may include promotion, merchandising, corporate communication, general messaging, advertisements or other paid programming or content that can be valued, and may be in any suitable motion graphics, web graphics, video, mobile media, or audio analog or digital format. The content may be entirely prerecorded, or may optionally include live drop-ins, streaming media, or dynamically-generated portions. The content may be digital or non-digital. Further, the content may comprise a dynamic video, a series of static images mixed with dynamic video, a series of purely static images, or a single static image.

A person walking by may glance at the display screen 40, or may optionally stop and watch the screen 40 for an extended period of time. A goal of the display system and method of the present invention is to accurately measure the audience of the display, and specifically the occurrence of each acquisition of the content by each member of the audience, i.e., at least one person, and to measure the duration of each acquisition of specific and unique content elements and to transform this acquisition data into an accurate value which is translated into a bill for the owner of the message of the displayed content.

The audience comprises in certain embodiments a transient plurality, as they stay by the display screen 40 for a relatively short period of time. Since the audience may comprise as few as one person, the present invention is intended to apply to an audience comprising at least one transient person. As will be readily understood by the skilled artisan, arrival and departure times for at least one transient person will likely be random, with respect to any time benchmarks in the case of video-based displayed content. By way of example, in the embodiments comprising content that is video based, an audience member may arrive at any point during the video, thereby acquiring a random subset of the whole and the duration of acquisition will vary as well.

Note that in some cases, the owner of the message of the displayed content may be an advertiser, a corporate department, a brand merchandiser, the provider of the displayed content may be an advertising agency that produced the content, and the owner of the display may be a different entity from both the advertiser and the advertising agency. Other alternatives are possible, such as for promotional spots for the store that houses the display. It will be understood that any bills generated by the display system are ultimately passed on to the appropriate entity, which is typically the advertiser. It will also be understood that the system 10 may display content from more than one content owner, e.g., an advertiser or a division within a corporation in the case of internal corporate communications, or more than one displayed content from the same content owner, e.g., advertiser, or any combination thereof.

FIG. 1 illustrates one embodiment of the display system 10 and shows a single person 20 in the crowd watching (acquiring) an advertisement or other content on the display screen 40. In this particular embodiment, the display screen comprises, without limitation, a video-based display screen 40, though as discussed above, there are many other types of display screens that are within the scope of the present invention. The gaze direction of the person is shown by the dashed line leaving the person's eye 30. In this case, the person 30 is looking at the screen 40, thereby acquiring the displayed content. The content on the display screen 40 is fed by a computer or other suitable server and/or network that keeps track of the time of day, so that the exact display begin and end times of a particular piece of content are known and recorded (data logged). The time stamp may be obtained by synchronization with an interne clock or other suitable device.

The display system 10 may comprise a video camera 50, mounted next to, within, or near the display screen 40, which processes sequential images of the person 20 watching the screen 40. In the processed images, one or both eyes 30 of the person 20 are visible. The display system 10 further comprises a dedicated programmed digital computer comprising a hard drive, memory and a processor as well as processing software processes the images, for identifying the human eyes in each picture, identifying a gaze direction for each pair of eyes, determining whether or not each pair (set) of eyes is looking at the display screen 40, i.e., whether any of the pairs of eyes acquired the displayed content on the display screen 40 and, if it is determined that any set of eyes are looking at the display screen 40, determining the length of the viewing or acquisition of the displayed content on the display screen 40.

Such eye tracking may, in various embodiments of the present invention comprising visually displayed content, be performed by any suitable known hardware and/or software and is not considered part of the present invention. For instance, the gaze direction may be determined from a comparison of the pupil location of one or both eyes to the other features on the face and head. A person looking straight ahead will have his or her pupils centered in the eye, a person looking to the left will have his or her pupils shifted to the left, and so forth. Such comparisons may be performed in real time on the video stream from a standard low-cost webcam, USB or IP camera.

Note that the number of eyes viewing the screen may be up to twice as large as the number of people viewing the screen; the software may include one or more suitable algorithms to ensure that if both eyes of a single person are identified as viewing the screen, then only one viewing/acquisition is recorded.

The video camera 50 may compile a series of images with regular or irregular intervals which are, in turn, sent to the programmed digital computer for processing. The number of images compiled per second may be 1, 2, 3, 4, 5, 6, 7, 8, 9, 10, 12, 15, 18, 20, 21, 24, 25, 27, 28, 30, 32, 35, 40, 45, 50, 55, 60, 72, 120, or any other suitable number. These images may, in certain embodiments, be processed essentially in real time to give a number of people acquiring the displayed content by viewing the screen 40, as a function of time.

For each acquisition of the displayed content by a viewing of the screen 40 in the illustrated embodiment, the software in the display system 10 records the time of day at which the screen is viewed, and the duration of the acquisition of the content by viewing. FIG. 2 is a plot of a sample acquisition of the displayed data by viewing the screen 40, as function of time.

Initially, in FIG. 2, the eye being tracked is looking away from the screen. When the tracked pair of eyes first looks at the screen, the time is recorded, noted on the plot of FIG. 2 as “viewing start time”. When the tracked pair of eyes eventually looks away from the screen, the time is also recorded, noted on the plot of FIG. 2 as “viewing end time”. The time duration between start and end times is noted as “viewing duration”.

Of the three quantities, “viewing start time”, “viewing end time” and “viewing duration”, note that only two are needed. The third can easily be derived from the other two.

For this document, the quantity “viewing time” is intended to mean the time of day at which the screen is viewed during the particular viewing and also indicates “acquisition time” of the displayed content by viewing the screen 40. For purposes of the present invention, “viewing” and “acquisition” are, in certain embodiments, equivalent and interchangeable. Here, “viewing time” or “acquisition time” may be the viewing start time, the viewing end time, or any intermediate time between the viewing start time and the viewing end time.

The present invention further covers the embodiments wherein a particular viewing/acquisition may extend from one daypart (and one billable rate) into the next daypart (with a different billable rate), or from one piece of content to another piece of content. For these cases, the cost may be pro-rated, so that the appropriate client may be charged for the actual time spent in each daypart and/or actual time spent in each unique piece of content.

In this document, “viewing duration”, i.e., acquisition duration, is as noted in FIG. 2, and represents the length of time for which a particular person looks at the video screen. In the cases when the viewing itself extends from one daypart to another, the viewing duration is pro-rated, with one portion of the viewing duration applying to a first daypart, and the remaining portion of the viewing/acquisition duration applying to the other daypart. Likewise, the viewing/acquisition durations may be similarly pro-rated if the viewing extends from one piece of content to another, or from one billable client to a different billable client. In addition, the viewing/acquisition durations may extend beyond two dayparts, or pieces of content; similar pro-rating may occur for extensions over three, four, five, or more than five items.

The viewing/acquisition time and viewing/acquisition duration may also be synchronized with the time of day, such as by an interne clock.

The display system 10 of FIG. 1 shows only one viewer. Naturally, since the display is set up in a public place and is designed to attract a crowd, the display may be used with more than one viewer simultaneously.

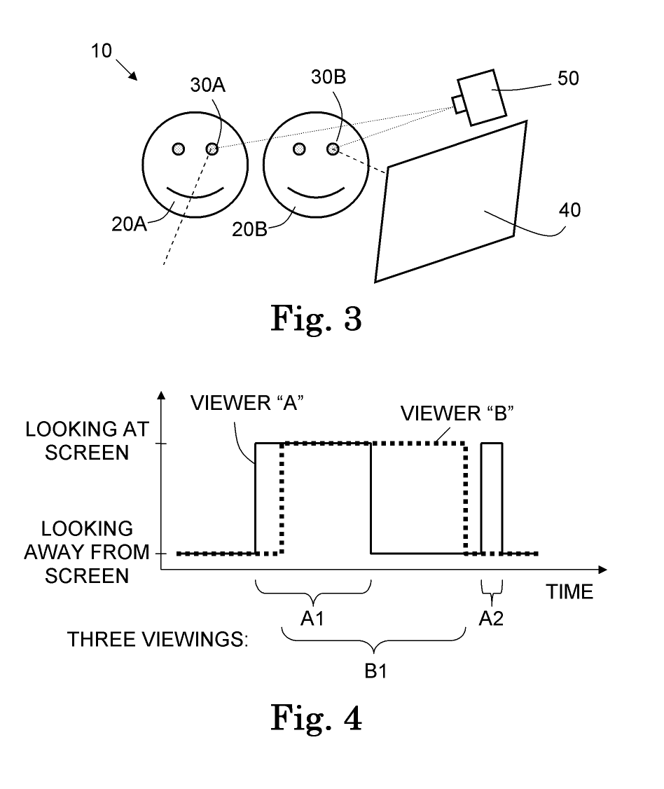

FIG. 3 is a schematic drawing of an exemplary display 10 with two simultaneous viewers 20A and 20B. In this exemplary drawing, at the moment of the drawing, person 20A is looking away from the screen 40 and person 30B is looking at the screen. Camera 50 captures images that include the eyes 30A and 30B of people 20A and 20B. The sequence of images captured by the camera 50 can track the viewings for each viewer.

FIG. 4 is a plot of sample viewings/acquisitions for two viewers, as function of time. In this example, there are two viewers, denoted as viewers “A” and “B”. Viewer “A” glances at the screen (forming acquisition “A1”), glances away from the screen, glances back briefly at the screen (forming acquisition “A2”), and finally looks away. Viewer “B” glances at the screen for one relatively long viewing (forming acquisition “B1”), and looks away. The viewings for the two viewers may overlap, as shown in FIG. 2. For this example, the two viewers “A” and “B” produce three content acquisitions, “A1”, “A2” and “B1”. The viewing/acquisition time and viewing/acquisition duration are noted for each. As with the example of FIG. 2, the “viewing time” may include any two of “viewing start time”, “viewing end time” and “viewing duration”. Again, “viewing” and “acquisition”, and derivations thereof, are used herein interchangeably.

FIG. 4 illustrates the embodiment wherein all the pictured viewings take place for a single piece of content. The present invention is not so limited. As noted above, any or all of the viewings/acquisitions may be suitably pro-rated if they extend beyond a single piece of content, a single billable rate, time of day, or a single billable client.

Although the display system 10 is shown with one viewer in FIG. 1, and with two viewers in FIG. 3, it will be understood that an arbitrary number of simultaneous viewers may be acquiring the displayed content by looking at or viewing the screen 40 at the display system 10. Such an arbitrary number of people may have their images captured by the camera 50, may have their eye gaze directions identified, and may be identified as “viewers”. In practicality, the number of viewers may be limited by the area within which the video screen can be viewed, in that only so many people can be within the practical viewing area of the display 10. The practical viewing/acquisition area is defined and proportional to the size of the display.

In addition to recording the number of people actually viewing/accessing the video screen 40 in the illustrated embodiment, as a function of time, the gaze (biometric/metric) technology may also tabulate the total number of people passing through and/or dwelling within the field of view of the camera 50, as a function of time. The total number of people may be useful for determining a billing rate for the AMPC. Such billing rates are described in more detail below, with respect to the lookup tables.

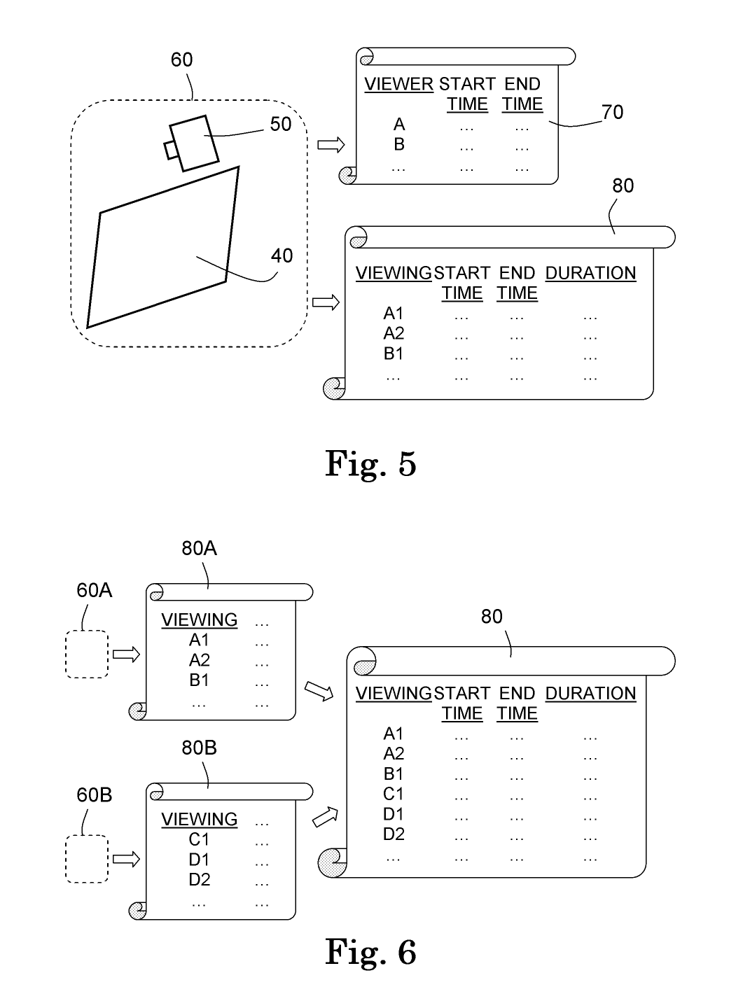

FIG. 5 is a schematic drawing of the information recorded at a typical display screen 40. As with the previous illustration and description, a video content display screen 40 will be used to describe certain embodiments of the present invention. It is, as is the case throughout this document, understood that the display need not be limited to video. Thus, the exemplary video display system 60 includes the video screen 40, the video camera 50 and one or more dedicated programmed digital computers with processing software, may or may not have a hard drive, memory and processor as described above (not shown). During use, the video screen 40 displays content, such as advertisements, provided by one or more clients. The video screen 40 is in a public place where people can come and go freely, and some may view/acquire the displayed content on the screen 40 while passing through the viewing/acquisition area, or stop/slow down for a period of time (dwell time) to watch/acquire the content, or multiple contents, being displayed on the display 40. The video camera 50 tracks and logs the viewing/acquisition behavior of the people (not shown) in front of the video screen 40, and the gaze technology's processing software/hardware (not shown) identifies which of the people are actually looking at, i.e., acquiring, the content displayed on the video screen 40. Both the content displayed on the screen 40 and the processed viewing/acquisition behavior of the actual viewers of unique piece(s) of content are synchronized to the time of day, in certain embodiments, through a common interne clock.

The recorded output from the gaze tracking system of the present invention includes at least two lists or databases.

As illustrated in FIGS. 5 and 6, the first database 70 is a list of viewers and their viewing behavior in front of the video screen 40, as a function of time, and may be referred to as a viewer log 70. In the example of FIG. 5, two viewers are shown, denoted as “A” and “B”, much like in FIGS. 3-4. For each viewer, a start time and an end time are recorded, representing the times at which the viewer enters and exits the field of view of the camera. Alternatively, there may be additional criteria for entries in viewer log 70, such as the start and end times at which the viewer stands in front of the display and/or remains generally stationary. There may also be entries for other quantities, such as traffic, dwell time, viewing durations, viewer age and ethnicity, and number of non-viewers. As noted above, the start and end times may equivalently be replaced by start time and duration, or duration and end time.

In some cases, the list treats each entering and exiting as a new viewer, so if the same person leaves the field of view/acquisition and then re-enters the field of view/acquisition, that person is treated as two separate viewers/acquirers of content. Alternatively, the list may recognize the particular person exiting and re-entering the field of view/acquisition as a single viewer, with multiple starting and ending times.

Such a log 70 of viewers or potential viewers may be useful for determining the billable rates for the display, in that it provides actual foot traffic numbers and viewing behavior as a function of time of day.

The second database 80, illustrated in FIG. 6, is a list of individual viewings/acquisitions of the content and viewing behavior associated with that display screen 40, and may be referred to as a viewing log 80. For each viewing, at least two of the following three quantities are recorded (the third can easily be recreated from the other two): start time, end time and duration. As with the example in FIG. 4, viewer “A” has two acquisitions of content, denoted as “A1” and “A2”, and viewer “B” has one acquisition of content, denoted as “B1”.

The two databases may be compared with an additional database that includes information regarding the content displayed on each screen. This additional database may include any or all of what content is displayed, start and end times for each content (referenced by the time of day), and/or which entity is the billable client for each content. Typically, this additional database is generated by the media server that feeds the display screen, rather than generated by the display itself. The time of day for this additional database may be determined from an internet clock, or by any other suitable method to ensure synchronization with the other databases.

As noted above, the billing may be pro-rated so that viewings/acquisitions that extend across two or more pieces of content and/or two or more dayparts may be billed suitably for the actual time spent viewing/acquiring each piece of content, at the appropriate billing rate.

The databases may be saved as a file on the display computer's local storage device, or externally collected and analyzed at a remote location, such as a hard drive or flash memory, or may be saved as a file on a locally or centrally-located dedicated programmable computer as described above. The databases themselves may be in any suitable format, including text, comma-separated value, tab-delimited text, and so forth.

In many cases, the databases may be broken into individual files that cover a particular block of time. For instance, there may be daily files, with databases 70 and 80 covering a particular 24-hour block. Or, there may be weekly files, with the databases 70 and 80 covering a particular seven-day block. Alternatively, any convenient block of time may be used.

In many cases, there may be more than one content display in the system. Such a system may comprise a network of displays, with each display being capable of displaying different content during any period of time. For instance, FIG. 6 is a schematic drawing of a video system having two displays 60A and 60B, each with its own video display and video camera. The two displays 60A and 60B generate their respective databases 80A and 80B of viewings/acquisitions and associated time/durations. In some cases, the databases 80A and 80B may be merged into the single database 80, and the single database 80 may be used for subsequent processing. In other cases, they may be left separate, and may be processed individually. For cases where the billable rates for the displays are the same, the single database 80 need not keep track of at which display the viewing occurred; for cases where the billable rates differ, the merged database 80 may optionally include an extra field denoting at which display the viewing/acquisition occurred.

Although two displays 60A and 60B are shown in FIG. 6, it will be understood that an arbitrary number of displays may be used, including 2, 3, 4, 5, 6, 7, 8, 9, 10, or more than 10.

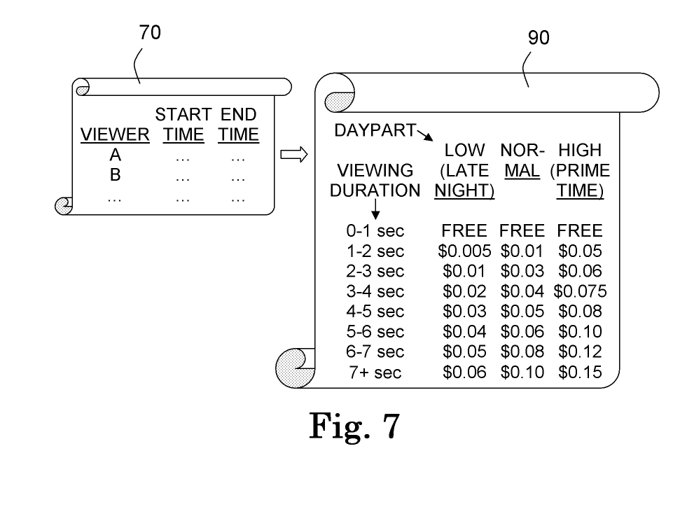

FIG. 7 is a schematic drawing of a sample viewer log 70 and sample billable rate lookup table 90. (JEFF_For a specific contracted client and/or unique piece of content. Log 70 is our processed data synchronized database that lists all content and the specific view durations associated with each piece of content and at what location. (I've included an example from Lowe's. We are not yet providing any valuation and/of billing reports. It's part of the IP discussion.

In general, the viewer log 70 provides traffic behavior (includes viewing behavior) information for its respective display. For instance, the log 70 may indicate how many people pass by a given display, as a function of time of day, and may also indicate how long these people may dwell at the display. If taken over an extended period of time, such as a week, several weeks or several months, the viewer logs 70 may provide raw potential audience numbers, and may answer the question of “How many people can this display ultimately reach?” More specifically, the viewer logs 70 may answer, “How many people can this display ultimately reach, as a function of the time of day?” Ultimately, this data is transformed by the present invention into value, i.e., “How valuable is this displayed content?”

The raw traffic numbers supplied by the viewer logs 70 may be used to determine billable rates, much like newspaper or magazine subscription numbers and TV and radio ratings may be used to determine ad rates. Much like radio ad rates, as discussed above, the rates for the display may be broken down into so-called “dayparts”, with each daypart having a different rate.

As an example, we describe the daypart rates for radio, in the context of listenership. We assume for this example that there are three dayparts, denoted as “prime time”, “normal” and “late night”. The dayparts definitions used for any particular displayed content will be unique to that content and potential customer(s) and/or client(s).

In general, in the U.S., radio listenership is heaviest during the commuting times, when people are in their cars. As a result, the morning and afternoon drive times have peak radio listenership, averaged over all radio listening times. These drive times may be considered “prime time”, and may command the highest ad rates, since they have the potential to reach the most listeners.

The workday, between the commuting times, is considered “normal” listening, and fewer people listen to the radio while they're at work than when they're getting to and from work. As a result, the ad rates for the “normal” dayparts are lower than during “prime time”.

Finally, the late night time slots, which are after most people have gone to bed, have the fewest overall radio listeners. These time slots have comparatively low listenership, compared with the workday or drive time slots, and ads run during these late night slots reach fewer potential listeners. As a result, the ad rates for the “late night” dayparts are lower than both the “normal” and “prime time” dayparts.

Other media may use other benchmarks to differentiate among ad rates. For instance, an ad run on the back cover of a magazine may command a much higher rate than an internal ad, because the back cover is exposed to a potentially larger set of eyes than one inside the magazine.

Likewise, the billing rates for content shown on the video display of the display may have analogous dayparts. The dayparts themselves and their associate billing rates may be based on the number of people that pass in front of the screen in a particular time interval for a particular time of day, the average time that people dwell in front of the screen for a particular time of day, the conversion ratio of those who pass in front of the display and those that actually look at the display, and/or any other suitable quantities.

A benefit to the display system embodiments described herein is that many or all of these quantities may be directly measured by the display, and may be tracked over time. Unlike the audience with a statistically-based ratings system typically used for broadcast media, the potential audience for the displays is directly measurable. In addition, the measurable quantities may be used to determine the effectiveness of other entities, like location in a store, proximity to entrances/exits, and effectiveness of the content itself. For instance, if a particularly effective ad runs on a display, and generates longer dwell times or a higher conversion ratio than what is typically seen, the client that provides that ad may receive that feedback in the form of hard numbers, which is always beneficial to the client. As another example, if a display is moved from one location to another, the performance of the display before and after the move may be directly compared with actual measured numbers. All of this information is beneficial to the client and to the operator of the video system. Another dimension of this embodiment is the use of actual numbers to optimize the design and use of the displayed content. (e.g. measured biometric performance may show that a red background on a particular piece of content commands an overall longer viewing duration than the same content produced with a blue background. Font size, color, audio, photos can all be tested and optimized based upon measured results in order to maximize the effectiveness of the messages communicated to the intended audience.

A sample billable rate schedule 90 is shown in FIG. 7. In this example, there are three dayparts, denoted as “Low (Late Night)”, “Normal” and “High (Prime Time)”, each with a different rate. It will be understood that more or fewer than three different rates may be used, such as 2, 3, 4, 5, 6, 7, 8, 9, 10 or more than 10.

The rates in this example are broken down by viewing duration, so that the client pays more for longer actual viewings of the content. In this example, there are eight ranges for viewing duration, including 0-1 sec, 1-2 sec, 2-3 sec, 3-4 sec, 4-5 sec, 5-6 sec, 6-7 sec, and more than 7 sec. It will be understood that any number of ranges may be used, and that the limits for each range may take on any suitable value.

Note that the rates in FIG. 7 are presented as a lookup table, where an actual daypart is compared with a plurality of predetermined dayparts, an actual viewing duration is compared with a plurality of predetermined ranges for viewing duration, and the cost is a predetermined value based on the ranges that include the actual values.

As an alternative, the rate schedule may include calculations or formulas. For instance, the rate for a particular daypart may be a constant value multiplied by the actual viewing duration. In other words, if the rate may be $0.02 per second of viewing, then a 3.5-second-long viewing would cost $0.07. The formulas may optionally include calculations that incorporate the actual time of day, in addition to or instead of the actual viewing time.

Once the rate schedule 90 or lookup table 90 has been generated, it may be used as a “contractually agreed cost per viewing” of the content. In general, the rate schedule is the cost that is agreed between the network owner (owner of the display and the video system, and/or the location at which the display resides) and the advertiser (content provider). In some cases, such a rate schedule may vary from advertiser to advertiser, with allowances like a discount for a large volume of purchase, and so forth.

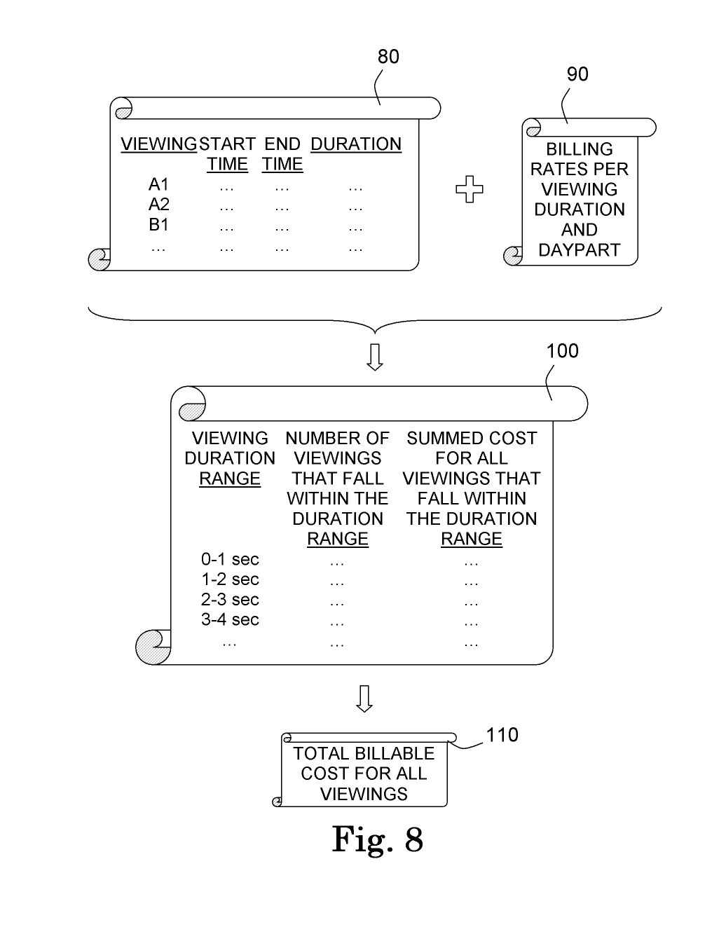

Once an advertiser or client has agreed on a particular rate schedule 90, and begins running content on the video screen(s) on one or more displays, then each viewing of the content becomes a billable event. FIG. 8 has a flow chart of a sample billing process.

The viewings log 80 includes information about each viewing, including start time, end time and duration (or includes any two of these three, from with the third can easily be recreated). Based on the time of day of each viewing, each viewing falls into one of the predetermined dayparts in the agreed-upon rate schedule 90. Based on the actual duration of each viewing, each viewing fits into one of the predetermined ranges for duration in the rate schedule 90. The cost for that particular viewing is taken from the rate schedule 90, or lookup table 90. This reading from the lookup table 90 may be repeated for each viewing.

The information from the viewings log 80 and the lookup table 90 are combined in an itemized summary 100. The information in the summary 100 may be useful to the client in that the client can see the real viewing durations, albeit grouped as a histogram into the predetermined ranges. As shown in FIG. 8, the summary lumps the number of viewings for each daypart into a single column; one cannot simply multiply one column by another to get the third column in this example.

Ultimately, the summed costs (third column of 100) are themselves summed, and one arrives at a total billable cost for all viewings 110. In practice, this may include all viewings in a particular time frame, such as for a week, several weeks, a month or several months.

The flow chart of FIG. 8 assumes that only a single display is being billed for. If there is more than one display, optionally with more than one lookup table 90 or billing schedule 90, then the total billable cost per display may be calculated, and the costs for all the displays may then be summed. The multiple displays may optionally run content independently of each other, with their own start and end times, and/or their own billing rate schedules. In general, if there are multiple displays running content provided by the same client, it may be preferable to first calculate the total cost for each display, then sum the costs for all displays, so that the client may be served with a single bill covering all the displays.

It will be understood that the flow chart of FIG. 8 is merely an example. There are many algebraically equivalent ways to form the subtotals and the summary 100. In some cases, the summary 100 is not needed, and the viewings log 80 and lookup table 90 may feed directly into the total billable amount 110.

In all cases, the documented acquisitions of the content, such as viewings/acquisitions of the displayed content and recording of the start and end times of the viewing/acquisition, are transformed into a predetermined dollar value. The transforming device may be a computer located at a kiosk or at a centralized location, which receives the start and end times of the displayed content, the start and end times of each viewing, pro-rates any applicable viewings/acquisitions to their associated content, accesses a predetermined lookup table that includes billing rates or values for each viewing/acquisition based on viewing/acquisition time of day and viewing/acquisition duration, determines a dollar value for each content acquisition, and compiles the dollar values for all the acquisitions of the content into a bill, to be sent to one or more clients for their respective displayed contents.

Ultimately, content acquisitions that extend across the transition from one piece of content to another may be broken into sections, with each section being associated with the content that is actually acquired. These sections may be treated independently of each other, so that one section of the viewing contributes to the bill for one piece of content, and the other section of the acquisition contributes to the bill for the other piece of content. The two pieces of content may be the same and repeated, or may optionally be entirely different pieces of content, optionally with different billing rates, and optionally from different billable clients. Once the billing process is understood for a single piece of content, it is straightforward to pro-rate the viewing time across multiple pieces of content and treat each piece of content separately for billing.

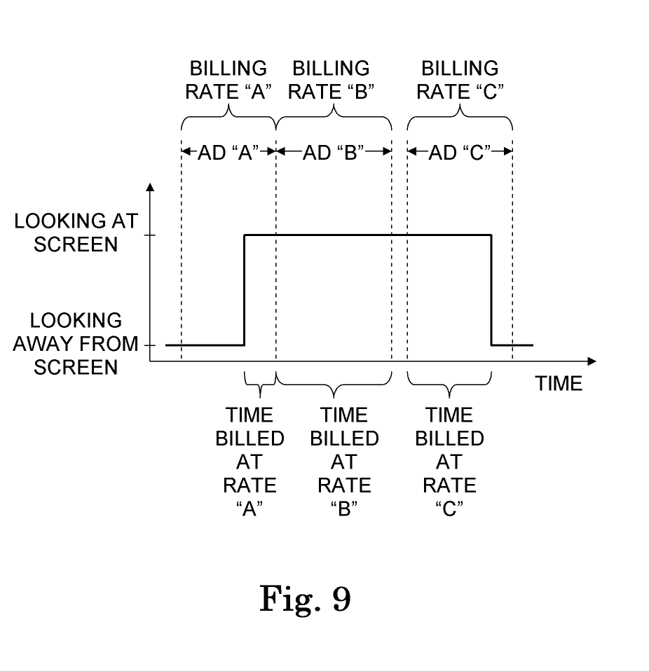

FIG. 9 shows an explicit example of acquisition of displayed content by viewings that extend from one piece of content into another. In this example, a single viewing temporally overlaps three different pieces of content.

In this example, a gaze from a particular viewer extends over three distinct pieces of content, which are denoted as “Ad A”, “Ad B” and “Ad C”. It will be understood that although the content is labeled as “Ads”, the content need not be advertisements, and may have any suitable function. Ad “B” runs immediately following Ad “A”, and after a pause, Ad “C” runs after Ad “B”.

The pause may represent a short interval of a blank screen, a decorative or informational pattern, such as a logo, a “Seasons Greetings” sign, or any suitable non-billable interval. The pause may arise from necessity, such as during a time required for a buffer or cache to fill, or may be optional, such as for aesthetic reasons. In this example, the display system may still record the information from the viewers, but need not assign a dollar value to it during the pause.

The start and end times of Ads A, B and C are recorded by the display, or are logged by the server that displays the ads (may be done locally or at a remote site server/processor). The start and end times are typically recorded as the time of day, and are typically synchronized with an internet clock. Similarly, the start and end times of each viewing are also typically synchronized with an internet clock.

Each of the three ads may have its own billing rate or rate schedule, much like billable rate lookup table 90 from FIG. 7. In some cases, all three rate schedules are identical. In the rest of the cases, the rate schedules may differ based on the time of day (daypart), the particular content being shown (with some ads being more lucrative than others), and/or which client is billable for the ad showings. As noted above, the rate schedule may be a flat rate per time (like two cents per second), may be a binned histogram-style of prices (as is shown in FIG. 7), a formula, or some combination of any of the above.

Because the start and end times of the ads and the start and end times of particular viewings are all synchronized against a common clock, such as an internet clock, the viewings are easily pro-rated based on what content is actually viewed. In the example of FIG. 9, there is a viewing of a relatively small fraction of Ad “A”, a full viewing of Ad “B”, and a viewing of most of Ad “C”. The time spent viewing, i.e., acquiring, each piece of displayed content is noted at the bottom of FIG. 9.

Each of the three billable times noted at the bottom of FIG. 9 may be processed and tallied independently. For instance, time “A” may be processed with billing schedule “A”, may be totaled with other viewings/acquisitions of Ad “A” on this display and/or other displays, and may ultimately be billed to the client that sponsors Ad “A”. Likewise, time “B” and time “C” may be processed similarly.

In addition to the acquisition start and end times being recorded by the display system, there may be other optional quantities that may be of use to the display operator and/or the client. For instance, in the case of video-based displayed content, the gaze tracking technology can capture information such as traffic, dwell time, viewing durations, viewer age and ethnicity, number of non-viewers, and so forth. Any or all of these quantities may be synchronized with an internet clock, and with the start and end times of the display content.

In addition, any or all of these optional quantities may be used to affect the rate schedule for the displayed content. For instance, for content that appeals primarily to women, such as women's clothing, it may be desirable to bill only for the number of viewings by women, and not for the viewings by men. Or, for a particular drug associated with the elderly, it may be desirable to bill only for the number of viewings by older people, and not for viewings by younger viewers. Such a tailoring of the recorded data may not be suitable for all applications, but it is possible in many cases, based on the types of attributes recorded by the display system.

Thus far, it has been assumed that the display system uses eye tracking to determine whether or not a person is paying attention to content displayed on the video screen. Although this may be the least invasive way of monitoring the person's interest in the video content, from the point of view of the person, there may also be other acceptable alternatives.

For instance, the video displays, as described above, may be passive display monitors, and may use any suitable display technology, such as liquid crystal displays, plasma, organic light emitting diodes, and so forth. In other cases, the video displays may support an interactive component, and may incorporate such elements as touch-screen sensitivity (which sense the fingerprints of people), radiofrequency identification tags (RFID), infrared scanning, magnetic card reading, optical card reading, RFID card reading, and/or any other quantitative biometrics that generate a datalog of all of the actions. Such a datalog may be referred to as “clickstream data”.

In some cases, the clickstream data, or any other element(s) gathered from an interactive display may be used to supplement or replace the eye tracking components described above. Similarly, an “acquisition” of the displayed content, when used with another biometric, may be analogous to a “viewing” of the displayed content when used with an eye tracker.

Note that the above processing of data involves several transmissions, receptions and transformations. Images, or the encoded data stream that represents images, are captured by, and transmitted from, a camera to a data processor, are received by a data processor, and are analyzed/processed by the data processor to extract viewing information from people's eyes in the image. The images are sequentially captured and processed, so that the extracted acquisition of content information may be transformed into an acquisition start time and an acquisition end time for each particular acquisition of the screen. The acquisition start time and the acquisition end time may be synchronized to the time of day with an internet clock. The video elements themselves are transmitted from a data server (either centrally located or local to the display) and received by the screen in the display. The video elements all have associated display start times and display end times. The display start and end times are correlated with the acquisition start and end times to produce a list of all acquisitions of each video element and an associated viewing duration for each viewing on the list. Any acquisition that extends past the beginning and/or end of a video element is pro-rated, so that the associated viewing duration corresponds to the actual length of time that video element is viewed/acquired. If an acquisition extends over two video elements, then there are two assigned acquisition durations, one to each of the two video elements, and each of the two assigned acquisition durations corresponds to the length of time for which each video element is actually viewed, i.e., acquired. Once the tally of all acquisition durations for each video element is compiled, the acquisition durations are assigned a dollar value based on a predefined or predetermined lookup table or rate schedule. The rate schedule may have histogram-style values for various bins, each bin having a range of viewing durations, and may also have histogram-style values for various dayparts, or display start and/or end times. Alternatively, instead of fixed values assigned to each bin, the rate schedule may have rates in dollars per time, so that the actual acquisition durations may be multiplied by the rates to get a dollar value. Finally, the dollar values are summed, are assigned to the respective billable clients for the video elements, and are distributed as bills.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. A method for transforming acquisition of displayed content into monetary value, comprising:
displaying at least one content, each displayed content corresponding to at least one client, to an audience comprising at least one transient person on a display device;
determining whether any of the at least one transients within the audience acquired at least part of the at least one displayed content and determining the length of any acquired content acquisition;
documenting all acquisitions, and the length of each individual acquisition, of the displayed content for any of the at least one transients within the audience with a documentation device;
transforming the documented acquisitions, and the lengths of each documented acquisition, into a monetary value with a transforming device; and
generating a bill for the client based on the documented acquisitions and length of each acquisition.

2. The method of claim 1, wherein the acquisitions, and lengths of each acquisition, of the at least one displayed content comprise viewings of dynamic video on the display device.

3. The method of claim 1, wherein the acquisitions, and lengths of each acquisition, of the at least one displayed content comprise viewings of dynamically displayed static images on the display device.

4. The method of claim 1, wherein the acquisitions, and lengths of each acquisition, of the at least one displayed content comprise viewings of a single static image on the display device.

5. The method of claim 1, wherein the acquisitions, and lengths of each acquisition, of the at least one displayed content comprise sensing radio frequency identification tags of the people in the transient plurality.

6. The method of claim 1, wherein the acquisitions, and lengths of each acquisition, of the at least one displayed content comprise sensing fingerprints (and/or touch) of the people in the transient plurality.

7. The method of claim 1, wherein the acquisitions, and lengths of each acquisition, of the at least one displayed content comprise sensing cards scanned by people in the transient plurality.

8. The method of claim 1, wherein the at least one displayed content comprises video-based content synchronized to a time of day.

9. The method of claim 8, wherein the video-based content comprises a plurality of sequentially displayed video elements, each video element having a display start time, a display end time, each video element further corresponding with a client.

10. The method of claim 1, wherein the at least one displayed content comprises a static image.

11. The method of claim 1,
wherein the content is displayed on a video screen; and
wherein the audience view the video screen.

12. The method of claim 1,
wherein the content is displayed on a plurality of video screens at different locations; and
wherein the audience acquires at least part of the displayed content by viewing at least one of the plurality of video screens.

13. The method of claim 1, further comprising:
tracking movement of the eyes of the people in the transient plurality; and
wherein the documenting device determines if and when each person in the transient plurality is looking at the display device.

14. The method of claim 1, wherein the documenting device records an acquisition time and an acquisition duration, the acquisition time being synchronized to the time of day, the acquisition duration including only the portion of the acquisition that temporally overlaps the content.

15. The method of claim 1,
wherein the transforming device provides a lookup table having predetermined billable values as a function of predetermined ranges for the time of day and predetermined ranges for acquisition duration;
wherein, for each acquisition of the content:
the transforming device selects a predetermined range that includes an acquisition time of day;
the transforming device selects a predetermined range that includes an acquisition duration; and
the transforming device assigns a corresponding billable value from the lookup table based on the selected predetermined ranges; and
wherein the transforming device sums the billable values for all the viewings of the display device to form the monetary value.

16. The method of claim 1, wherein the transforming device provides a lookup table having predetermined billable rates as a function of predetermined ranges for the time of day and predetermined ranges for acquisition duration;
wherein, for each acquisition of the content:
the transforming device selects a predetermined range that includes an acquisition time of day;
the transforming device selects a predetermined range that includes an acquisition duration; and
the transforming device assigns a corresponding billable rate from the lookup table based on the selected predetermined ranges; and
the transforming device multiplies the billable rate by the acquisition duration to form a billable value; and
the transforming device sums the billable values for all acquisitions of the display device to form the monetary value.

17. A video content display system, comprising:
a plurality of display kiosks, each kiosk comprising:
a video screen for display video content to a transient plurality of people, the video content being synchronized to a time of day;
a video camera proximate the video screen for periodically capturing images of the transient plurality of people; and
means for documenting from the captured images all viewings of the video screen for all people in the transient plurality, the documenting comprising recording a viewing time and a viewing duration, the viewing time being synchronized to the time of day, the viewing duration including only the portion of the viewing that temporally overlaps the video content;
a centralized server for receiving from the respective kiosks periodic reports of the recorded viewing times and viewing durations; and
a plurality of lookup tables stored on the centralized server, each lookup table in the plurality corresponding to a kiosk, each lookup table including predetermined billing rates as a function of viewing time and viewing duration;
wherein the centralized server determines a total billable cost for the video content from the recorded viewing times, from the corresponding recorded viewing durations and from the respective lookup tables of predetermined billing rates.

18. The system of claim 17, wherein the video content comprises a plurality of advertisements.

19. The system of claim 18,
wherein the advertisements are provided by a plurality of clients; and
wherein each client is billed a total billable cost only for viewings of its own advertisements.

20. The system of claim 17, wherein the synchronizations to the time of day comprise synchronization to an interne clock.

21. The system of claim 17, wherein the means for documenting comprises:
identification of eyes of the people within each captured image;
determination of a gaze direction for each eye within each captured image; and
determination of whether or not each respective eye is looking at the video screen.

22. The system of claim 17, wherein the means for documenting occurs at the respective kiosk, away from the centralized server.

23. A method for transforming acquisition of displayed video content into monetary value, comprising:
receiving at a reception module:
display start times and display end times for a plurality of sequentially displayed video content comprising more than one video element, each video element having a corresponding billable client; and
viewing start times and viewing end times for a plurality of viewings, each viewing in the plurality corresponding to a period during which a person in a transient plurality of people views a screen on which the video elements are sequentially displayed;
transferring to a processing module the display start times, the display end times, the viewing start times and the viewing end times;
assigning at least one viewing duration to each viewing and at least one video element to each viewing, the at least one viewing duration corresponding to the actual length of the at least one video element viewed by the respective person,
pro-rating each viewing that extends temporally across more than one video element to have an assigned viewing duration and an assigned video element for each video element over which the viewing extends;
transforming the assigned viewing durations and the assigned video elements for all viewings and video elements to produce, for each video element, a list of viewing durations during which the associated video element is viewed;
assigning a billable value to each viewing duration in the list of viewing durations, for each video element;
summing the assigned billable values for all durations in each list of viewing durations to produce a per-screen cost, for each video element;
grouping the per-screen costs by billable client associated with the respective video elements; and
transforming the grouped per-screen costs into a bill, for each billable client.

24. The method of claim 23, wherein the assigning the billable value step comprises:
providing a rate schedule having predetermined billable values as a function of predetermined ranges for the display start time and predetermined ranges for viewing duration; and
for each viewing of the video element:
selecting a predetermined range that includes the display start time;
selecting a predetermined range that includes the viewing duration; and
assigning a corresponding billable value from the lookup table based on the selected predetermined ranges.

25. The method of claim 23, wherein the assigning the billable value step comprises:
providing a rate schedule having predetermined billing rates, in cost per time, as a function of predetermined ranges for the display start time and predetermined ranges for viewing duration; and
for each viewing of the video element:
selecting a predetermined range that includes the display start time;
selecting a predetermined range that includes the viewing duration; and
assigning a corresponding billable rate from the lookup table based on the selected predetermined ranges; and
multiplying the billable rate by the associated viewing duration.
